(19) United States
(12) Patent Application Publication
(10) Pub. No.: US 2012/0178656 A1
(43) Pub. Date: Jul. 12, 2012

(54) Dispersant Viscosity Modifiers

(75) Inventors: Michael R. Sutton, Matlock (GB); William R.S. Barton, Belper (GB); David Price, Littleover (GB); Mark C. Davies, Belper (GB)

(73) Assignee: THE LUBRIZOL CORPORATION, Wickliffe, OH (US)

(21) Appl. No.: 13/382,351

(22) PCT Filed: Jul. 6, 2010
(86) PCT No.: PCT/US10/41037

§ 371 Date: Mar. 27, 2012

Related U.S. Application Data
(60) Provisional application No. 61/223,822, filed on Jul. 8, 2009.

(51) Int. Cl. C10M 169/04; C08F 236/10

(52) U.S. Cl. 508/184; 508/283; 508/551; 508/557; 508/558; 525/285

(57) ABSTRACT

The disclosed invention relates to a composition comprising a grafted polymer. The polymer backbone comprises an olefin block and a vinyl aromatic block. The polymer backbone is grafted with a pendant carbonyl containing group, the grafting being conducted in oil in the presence of an initiator. The carbonyl containing-group is optionally substituted to provide ester, imide and/or amide functionality. The grafted polymer is useful as a dispersant viscosity modifier in lubricating compositions such as engine oils.

### FIELD OF INVENTION

This invention relates to dispersant viscosity modifiers and to a process for making the dispersant viscosity modifiers. These dispersant viscosity modifiers are useful as additives for lubricating compositions, for example, engine oils.

### BACKGROUND

The use of dispersant viscosity modifiers in engine oils is known.

### SUMMARY

There is an increased emphasis in the marketplace on engine oils that provide enhanced fuel economy and longer drain intervals. Existing passenger car motor oil (PCMO) and heavy duty diesel (HDD) engine oil formulations may address both of these issues with partial or total replacement of components that hinder fuel economy, such as polyisobutylene (PIB) based dispersants, with suitably efficient dispersant viscosity modifiers (DVM) to improve fuel economy or provide a boost in soot handling. These polymers may be referred to as bifunctional polymers. Examples of PIB based dispersants include products derived from the reaction of terminal alkene groups of PIB with maleic anhydride followed by treatment of the PIB bound anhydride with polyethylene amines.

The drive for bifunctional polymers of this type has led to the commercialization of olefin copolymer (OCP) based DVMs such as Hitec™ 5777 (a product of Afton which is believed to be an ethylene-propylene copolymer grafted with maleic anhydride and further reacted with 4-aminodiphenylamine). However, a problem with the use of OCP based DVMs relates to piston deposition which is believed to be caused by OCP degradation. Hydrogenated styrene-butadiene resins (SBR) can be used as viscosity improvers and have been shown to yield lower piston deposition than OCP based DVMs. However, unfunctionalized random copolymers of styrene and butadiene typically provide insufficient soot dispersancy.

When functionalized, SBR based DVMs provide for soot dispersancy. While it is desirable to use functionalized SBR based DVMs, it has been found that processes for making such functionalized SBR based DVMs, using solution phase grafting (e.g., grafting in chlorobenzene or t-butylbenzene) are inefficient and costly. This invention provides a solution to this problem.

According to one embodiment, the present invention relates to a polymer composition, comprising: a grafted polymer comprising a polymer backbone and a pendant carbonyl containing group, the backbone comprising block A and block B, block A comprising at least one olefin polymer block, block B comprising at least one vinyl aromatic polymer block, the mole ratio of block A to the combination of block A plus block B being in the range from 0.5 to 0.9; the pendant carbonyl containing group being grafted on block A and/or block B, the carbonyl containing group being optionally further substituted to provide an ester, imide and/or amide functionality, the grafting of the pendant carbonyl containing group on block A and/or block B being conducted in oil at a temperature in the range from 100 to 250° C. in the presence of an initiator.

The present material alternatively may be described as a composition, comprising: a grafted polymer comprising a polymer backbone and a pendant carbonyl containing group, the backbone comprising at least one of block A and at least one of block B, block A comprising an olefin polymer block, block B comprising a vinyl aromatic polymer block, the mole ratio of monomer units in block A to monomer units in the combination of block A plus block B being in the range from 0.5 to 0.9; the pendant carbonyl containing group being grafted on block A and/or block B, the carbonyl containing group being optionally further substituted to provide an ester, imide and/or amide functionality, the grafting of the pendant carbonyl containing group on to block A and/or block B being conducted in oil at a temperature in the range from 100 to 250° C. in the presence of an initiator.

The grafted polymers of the invention may provide sufficient dispersancy to reduce dispersant concentrations with the distinct benefit of improved cleanliness over existing DVM products. An advantage of the invention is that since the polymer is grafted in oil, it is not necessary to separate the grafted polymer from the oil in order to use the polymer in an oil-based lubricating composition. That is, the same oil used in the grafting can also be used as the base oil in an oil-based lubricating composition.

According to a further aspect of the invention, the inventive composition further comprises grafted oil, the grafted oil comprising oil with a carbonyl containing group grafted on the oil.

According to a still further aspect of the invention, the weight ratio of grafted polymer to grafted oil is in the range from 5:1 to 1:5, or from 3:1 to 2:1.

According to a still further aspect of the invention, the grafted polymer comprises a copolymer that is not a tapered copolymer, and block A contains from 20 mol % to 80 mol %, or from 30 mol % to 70 mol %, repeat units that contain branched alkyl groups, that is, that contain alkyl branches or alkyl branching groups (such as ethyl groups).

According to a still further aspect of the invention, the grafted polymer comprises a copolymer which is a tapered copolymer, and block A contains from 40 mol % to 80 mol %, or from 50 mol % to 75 mol %, repeat units that contain branched alkyl groups, that is, alkyl branches.

According to a still further aspect of the invention, the grafted polymer comprises repeat units derived from an aliphatic diene and repeat units derived from an alkenyl arene.

According to a still further aspect of the invention, the grafted polymer comprises a backbone comprising repeat units derived from styrene and butadiene.

According to a still further aspect of the invention, the grafted polymer comprises a diblock copolymer.

According to a still further aspect of the invention, the grafted polymer comprises a sequential block copolymer.

According to a still further aspect of the invention, the pendant carbonyl-containing group is derived from a carboxylic acid or a derivative thereof, the derivative comprising an anhydride, halide, or alkyl ester.

According to a still further aspect of the invention, the pendant carbonyl containing group is derived from maleic anhydride.

According to a still further aspect of the invention, the grafted polymer has a weight average molecular weight in the range from 1000 to 1,000,000, or in the range from 10,000 to 250,000.

According to a still further aspect of the invention, the grafted polymer has a polydispersity in the range from 1 to 1.6, or in the range from 1.01 to 1.55.

According to a still further aspect of the invention, the grafted polymer comprises double bonds available for hydrogenation and from 50 to 100% of the double bonds available for hydrogenation are hydrogenated.

According to a still further aspect of the invention, the oil comprises an oil of lubricating viscosity.

According to a still further aspect of the invention, the oil comprises a natural oil and/or synthetic oil.

According to a still further aspect of the invention, the oil comprises a hydrocracked oil, hydrogenated oil, hydrotreated oil, unrefined oil, refined oil, re-refined oil, or a mixture of two or more thereof.

According to a still further aspect of the invention, the initiator comprises a hydrocarbyl peroxide, a dihydrocarbyl peroxide, an alkyl perester, and alkyl peracid, an alkanoate, or a mixture of two or more thereof.

According to a still further aspect of the invention, the amide and/or imide functionality is provided by an amine.

According to a still further aspect of the invention, the amine comprises a primary or secondary amine.

According to a still further aspect of the invention, the amine comprises Fast Violet B, Fast Blue BB, Fast Blue RR, aniline, N-alkylanilines, di-(para-methylphenyl)amine, 4-aminodiphenylamine, N,N-dimethylphenylenediamine, naphthylamine, 4-(4-nitrophenylazo)aniline, sulfamethazine, 4-phenoxyaniline, 3-nitroaniline, 4-aminoacetanilide (N-(4-aminophenyl)acetamide)), 4-amino-2-hydroxy-benzoic acid phenyl ester (phenyl amino salicylate), N-(4-amino-phenyl)-benzamide, benzyl-amines, 4-phenylazoaniline, para-ethoxyaniline, para-dodecylaniline, cyclohexyl-substituted naphthylamine, thienyl-substituted aniline, or a mixture of two or more thereof.

According to a still further aspect of the invention, the amine functionality is derived from at least one of N-p-diphenylamine 1,2,3,6-tetrahydrophthalimide; 4-anilinophenyl methacrylamide; 4-anilinophenyl maleimide; 4-anilinophenyl itaconamide; acrylate and methacrylate esters of 4-hydroxydiphenylamine; the reaction product of p-aminodiphenylamine or p-alkylaminodiphenylamine with glycidyl methacrylate; the reaction product of p-aminodiphenylamine with isobutyraldehyde, derivatives of p-hydroxydiphenylamine; derivatives of phenothiazine; vinyl-containing derivatives of diphenylamine; or a mixture of two or more thereof.

According to a still further aspect of the invention, the amine comprises aminodiphenyl amine, dimethylaminopropyl amine, aminopropylimidazole, dimethylphenyl amine, 4-(4-nitrophenyl azo) aniline, Fast Blue RR, or a mixture of two or more thereof.

According to one embodiment, the inventive composition comprises a concentrate, the concentrate comprising the foregoing polymer composition and a diluent, the weight ratio of the grafted polymer (including grafted oil) to the diluent being in the range from 1:99 to 99:1, or from 80:20 to 10:90

According to one embodiment, the inventive composition comprises a fully formulated lubricating composition, the lubricating composition comprising a major amount of an oil of lubricating viscosity, and a minor dispersant viscosity modifying amount of the foregoing polymer composition.

According to a further aspect of the invention, the lubricating composition comprises an engine oil, wherein the lubricating composition has at least one of (i) a sulphur content of 0.8 wt % or less, (ii) a phosphorus content of 0.2 wt % or less, or (iii) a sulphated ash content of 2 wt % or less.

According to a further aspect of the invention, the lubricating composition comprises an engine oil wherein the lubricating composition has a (i) a sulphur content of 0.5 wt % or less or even 0.4 wt % or less, (ii) a phosphorus content of 0.1 wt % or less or even 0.09 or 0.08 wt % or less, and (iii) a sulphated ash content of 1.5 wt % or less or even 1 wt or less.

According to a further aspect of the invention, the invention relates to the use of the foregoing polymer composition in an engine oil for a 2-stroke or a 4-stroke internal combustion engine, a gear oil, an automatic transmission oil, a hydraulic fluid, a turbine oil, a metal working fluid or a circulating oil.

According to a further aspect of the invention, the invention relates to the use of the foregoing polymer composition in an engine oil for a 2-stroke or a 4-stroke marine diesel internal combustion engine.

According to one embodiment, the invention relates to a process, comprising: grafting a carbonyl containing group on a polymer backbone in oil in the presence of an initiator at a temperature in the range from 100° C. to 250° C. to form a grafted polymer; the polymer backbone comprising block A and block B, block A comprising at least one olefin polymer block, block B comprising at least one vinyl aromatic polymer block, the mole ratio of block A to the combination of block A plus block B being in the range from 0.5 to 0.9; the carbonyl containing group being derived from a carboxylic acid or derivative thereof, the derivative being an anhydride, halide or alkyl ester, the carbonyl containing group being grafted on block A and/or block B, the carbonyl containing group being optionally further substituted to provide ester, imide and/or amide functionality.

According to a further aspect of the inventive process, grafted oil is formed, and the weight ratio of grafted polymer to grafted oil is in the range from 5:1 to 1.5:1, or from 3:1 to 2:1.

According to a still further aspect of the inventive process, the polymer comprises repeat units derived from an aliphatic diene and repeat units derived from an alkylene arene.

According to a still further aspect of the inventive process, the polymer comprises a backbone comprising repeat units derived from styrene and butadiene.

According to a still further aspect of the inventive process, the carboxylic acid derivative comprises an anhydride.

According to a still further aspect of the inventive process, the anhydride comprises maleic anhydride.

According to a still further aspect of the inventive process, the grafted polymer has a weight average molecular weight in the range from 1000 to 1,000,000, or in the range from 10,000 to 250,000.

According to a still further aspect of the inventive process, the grafted polymer has a polydispersity in the range from 1 to 1.6, or in the range from 1.01 to 1.55.

According to a still further aspect of the inventive process, the grafted polymer comprises double bonds available for hydrogenation and from 50 to 100% of the double bonds available for hydrogenation are hydrogenated.

According to a still further aspect of the inventive process, the oil comprises an oil of lubricating viscosity.

According to a still further aspect of the inventive process, the oil comprises a natural oil and/or synthetic oil.

According to a still further aspect of the inventive process, the oil comprises a hydrocracked oil, hydrogenated oil, hydrotreated oil, unrefined oil, refined oil, re-refined oil, or a mixture of two or more thereof.

According to a still further aspect of the inventive process, the initiator comprises a hydrocarbyl peroxide, a dihydrocarbyl peroxide, an alkyl perester, an alkyl peracid, an alkanoate, or a mixture of two or more thereof.

According to a still further aspect of the inventive process, the imide and/or amide functionality is provided by an amine.

According to a still further aspect of the inventive process, the amine comprises a primary or secondary amine.

According to a still further aspect of the inventive process, the amine comprises Fast Violet B, Fast Blue BB, Fast Blue RR, aniline, N-alkylanilines, di-(para-methylphenyl)amine, 4-aminodiphenylamine, N,N-dimethylphenylenediamine, naphthylamine, 4-(4-nitrophenylazo)aniline, sulfamethazine, 4-phenoxyaniline, 3-nitroaniline, 4-aminoacetanilide (N-(4-aminophenyl)acetamide)), 4-amino-2-hydroxy-benzoic acid phenyl ester (phenyl amino salicylate), N-(4-amino-phenyl)-benzamide, benzyl-amines, 4-phenylazoaniline, para-ethoxyaniline, para-dodecylaniline, cyclohexyl-substituted naphthylamine, thienyl-substituted aniline, or a mixture of two or more thereof.

According to a still further aspect of the inventive process, the amine functionality is derived from at least one of N-p-diphenylamine 1,2,3,6-tetrahydrophthalimide; 4-anilinophenyl methacrylamide; 4-anilinophenyl maleimide; 4-anilinophenyl itaconamide; acrylate and methacrylate esters of 4-hydroxydiphenylamine; the reaction product of p-aminodiphenylamine or p-alkylaminodiphenylamine with glycidyl methacrylate; the reaction product of p-aminodiphenylamine with isobutyraldehyde, derivatives of p-hydroxydiphenylamine; derivatives of phenothiazine; vinyl-containing derivatives of diphenylamine; or a mixture of two or more thereof.

According to a still further aspect of the inventive process, the amine comprises aminodiphenyl amine, dimethylaminopropyl amine, aminopropylimidazole, dimethylphenyl amine, 4-(4-nitrophenyl azo) aniline, Fast Blue RR, or a mixture of two or more thereof.

### BRIEF DESCRIPTION OF THE DRAWINGS

FIGS. 1-3 show XUD-11 soot screen test results for test samples described in Example 3.

### DETAILED DESCRIPTION

All ranges and ratio limits disclosed in the specification and claims may be combined in any manner. It is to be understood that unless specifically stated otherwise, references to “a,” “an,” and/or “the” may include one or more than one, and that reference to an item in the singular may also include the item in the plural.

The term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include:

(i) hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring);

(ii) substituted hydrocarbon substituents, that is, substituents containing non-hydrocarbon groups which, in the context of this invention, do not alter the predominantly hydrocarbon nature of the substituent (e.g., halo (especially chloro and fluoro), hydroxy, alkoxy, mercapto, alkylmercapto, nitro, nitroso, and sulphoxy);

(iii) hetero substituents, that is, substituents which, while having a predominantly hydrocarbon character, in the context of this invention, contain other than carbon in a ring or chain otherwise composed of carbon atoms. Heteroatoms include sulphur, oxygen, nitrogen, and encompass substituents as pyridyl, furyl, thienyl and imidazolyl. In general, no more than two, preferably no more than one, non-hydrocarbon substituent will be present for every ten carbon atoms in the hydrocarbyl group; typically, there will be no non-hydrocarbon substituents in the hydrocarbyl group.

The term “branched alkyl groups” includes branched alkyl groups that are optionally further substituted. As otherwise stated, alkyl branches on the polymer chain may or may not themselves be further branched.

Unless otherwise indicated, molecular weights are determined by gel permeation chromatography using polystyrene standards.

It is known that some of the materials described herein may interact in the final formulation, so that the components of the final formulation may be different from those that are initially added. The products formed thereby, including the products formed upon employing the composition of the present invention in its intended use, may not be susceptible of easy description. Nevertheless, all such modifications and reaction products are included within the scope of the present invention; the present invention encompasses compositions prepared by admixing the components described herein.

Each of the documents referred to herein is incorporated herein by reference. Except in the Examples, or where otherwise explicitly indicated, all numerical quantities in this description or in the appended claims specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention may be used together with ranges or amounts for any of the other elements.

### Grafted Polymer

The grafted polymer comprises a polymer backbone and a pendant carbonyl containing group grafted on the polymer backbone. The grafted polymer may comprise block A and block B. These may be represented by the formulae:

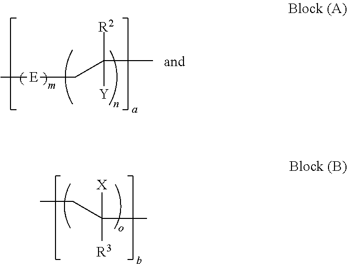

wherein

a and b are coefficients for their corresponding monomer repeat units, wherein the ratio of a/(a+b) may be 0.5 to 0.9, or 0.55 to 0.8, or 0.6 to 0.75;

R² is H, alkyl, or alkyl-Z, with the proviso that 5 mol % to 95 mol of the R² groups may be alkyl or alkyl-Z groups (in one embodiment, R² is not H);

R³ is an arene group or an alkyl-substituted arene group, wherein the pendant carbonyl-containing group may be attached to the arene group;

E is an alkylene group or an alkenylene group (typically E is a C₄ group);

X, Y and Z are independently H or pendant carbonyl-containing groups, with the proviso that at least one of X, Y and Z is the pendant carbonyl-containing group; and

m, n, and o are numbers of repeat units for the moieties described above, with the proviso that each repeat unit is present in sufficient quantities to provide the polymer with an appropriate number average molecular weight, and wherein the polymer is terminated with a polymerisation terminating group, and with the proviso that when the copolymer comprises a tapered copolymer block, A contains repeat units with greater than 38.5 mol % to 95 mol % of branched, optionally substituted alkyl groups (that is, alkyl branching groups).

The grafted polymer may be represented by the formula:

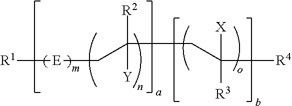

wherein

a and b are coefficients for their corresponding monomer repeat units, wherein the ratio of a/(a+b) may be 0.5 to 0.9, or 0.55 to 0.8, or 0.6 to 0.75;

R¹ is H, t-alkyl, sec-alkyl, CH₃—, R′₂N—, or aryl;

R² is H, alkyl or alkyl-Z, with the proviso that in block (A) 5 mol to 95 mol % of the R² groups may be alkyl or -alkyl-Z groups;

R³ is an arene group or an alkyl-substituted arene group, wherein the pendant carbonyl-containing group may be attached to the arene group;

R⁴ is a polymerization terminating group, such as H or alkyl;

E is an alkylene group or an alkenylene group (typically E is a C₄ group);

X, Y and Z are independently H or a carbonyl-containing group, with the proviso that at least one of X, Y and Z is the pendant carbonyl-containing group;

R′ is a hydrocarbyl group, and

m, n, and o are numbers of repeat units for the moieties described above, with the proviso that each repeat unit is present in sufficient quantities to provide the hydrogenated copolymer with an appropriate number average molecular weight, and with the proviso that when the copolymer comprises a tapered copolymer, block A contains repeat units with greater than 38.5 mol % to 95 mol % of branched, optionally substituted alkyl groups (that is, alkyl branching groups).

The grafted polymer may be made by the process comprising:

(a) polymerizing (i) a vinyl aromatic polymer block and (ii) an olefin polymer block followed by step (b) and optionally step (c);

(b) reacting, under grafting conditions, a carbonyl containing compound with the polymer from step (a) in oil in the presence of an initiator to form a grafted polymer, the grafted polymer comprising a polymer backbone and a pendant carbonyl containing group; optionally, followed by hydrogenating the polymer from step (b); and

(c) optionally reacting the grafted polymer of step (b) with at least one of an alcohol, an amine and/or a nitrogen-containing monomer (typically forming an ester, amide and/or an imide) to form a functionalized polymer.

The grafted polymer may be hydrogenated as provided for in (b). The hydrogenated polymer may be hydrogenated at 50% to 100%, or 90% to 100% or 95% to 100% of available double bonds (which does not include aromatic unsaturation).

Block A may be derived from one or more aliphatic dienes, for example, butadiene. Suitable dienes used to generate the block represented by A may include 1,4-butadiene or isoprene. The diene may comprise 1,4-butadiene. In one embodiment block A may be substantially free of, or free of, isoprene-derived units.

As used herein the term “substantially free of isoprene” means the polymer contains isoprene-derived units at not more than impurity levels, typically, less than 1 mol % of the polymer, or 0.05 mol % or less of the polymer, or 0.01 mol % or less of the polymer, or 0 mol % of the polymer.

The diene may polymerize by either 1,2-addition or 1,4-addition. The degree of 1,2-addition may be defined by the relative amounts of repeat units of branched alkyl groups (also defined herein as R²). Any initially-formed pendant unsaturated or vinyl groups, upon hydrogenation, may become alkyl branches (“branched alkyl groups”).

Block A (when not in a tapered copolymer) may contain from 20 mol % to 80 mol %, or 25 mol % to 75 mol %, or 30 mol % to 70 mol %, or 40 mol % to 65 mol % of repeat units of branched alkyl groups.

A tapered copolymer, may contain 40 mol % to 80 mol %, or 50 mol % to 75 mol % of block A containing repeat units of branched alkyl groups (or vinyl groups).

Block B may be derived from one or more vinyl aromatic monomers. The vinyl aromatic monomer may be an alkylene arene.

These may include styrene or alkylstyrene (e.g. alpha-methylstyrene, para-tert-butylstyrene, alpha-ethylstyrene, and para-lower alkoxy styrene). In one embodiment the vinyl aromatic monomer is styrene.

The polymer may be prepared by anionic polymerization techniques. While not wishing to be bound by theory, it is believed that anionic polymerization initiators containing alkali metals and/or organometallic compounds are sensitive to interactions between the various metals and the counterion and/or solvent. In order to prepare a polymer with increasing amounts of diene polymerized with a larger amount of 1,2-addition, it is typical to employ a polar solvent, for example, tetrahydrofuran (THF). Further employing an initiator with a lower atomic mass is suitable (for example use lithium rather than cesium). In different embodiments butyl lithium or butyl sodium may be used as initiators. Typical anionic polymerization temperatures such as below 0° C., or −20° C. or less may be employed. A more detailed description of methods suitable for preparing a polymer with a greater amounts of diene 1,2-addition stereospecificity is found in Kirk-Othmer Encyclopedia of Chemical Technology, Third Edition, Volume 4, pages 316-317 or in Anionic Polymerisation, Principles and Practical Applications, Edited by Henry L. Hsieh and Roderic P. Quirk, pages 209 and 217, 1996, Marcel Dekker.

The olefin polymer block may be formed with a large amount of 1,2-addition (for example, 5 mol % to 95 mol % of branched groups) by employing the processes or methods described in U.S. Pat. Nos. 5,753,778 (discloses in column 3, lines 1 to 33 a process using an alkyllithium initiator for selectively hydrogenating a polymer); 5,910,566 (discloses in column 3, lines 13 to 43 a suitable process, solvent and catalyst for hydrogenating a conjugated diene); 5,994,477 (discloses in column 3, line 24 to column 4, line 32 a method for selectively hydrogenating a polymer); 6,020,439 (column 3, lines 30-52 discloses a suitable catalyst); and 6,040,390 (discloses in column 9, lines 2-17 a suitable catalyst). Typically the amount of 1,2-addition disclosed in the Examples of these patents range from 30 to 42% of the butadiene units).

The polymer backbone may be derived from styrene and butadiene with 5 mol % to 95 mol % of butadiene. An example of such a material is Lubrizol®7408A which is an SBR with a number average molecular weight of 120,000 and a styrene content of 30% by weight.

The polymer backbone may be derived from one of the SBRs available from Dynasol. One such material has a number average molecular weight of 130,000 and a styrene content of 30% by weight. Another has a number average molecular weight of 90,000 and a styrene content of 30% by weight.

The pendant carbonyl containing group may be derived from a carboxylic acid or derivative thereof. The derivatives may include anhydrides, acyl halides, lower alkyl (i.e., up to 7 carbon atoms) esters thereof, amides, imides, or mixtures of two or more thereof. These may include mono-carboxylic acids (e.g., acrylic acid and methacrylic acid) and esters, e.g., lower alkyl esters thereof, as well as dicarboxylic acids, anhydrides and esters, e.g., lower alkyl esters thereof. Examples of dicarboxylic acids, anhydrides and esters may include maleic acid or anhydride, fumaric acid, or ester, such as lower alkyl, i.e., those containing no more than 7 carbon atoms on the alkyl ester group.

The dicarboxylic acids, anhydrides and esters may be represented by the groups of formulae:

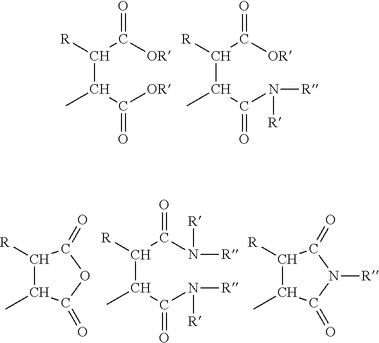

In these formulae, R may hydrogen or hydrocarbyl of up to 8 carbon atoms, such as alkyl, alkaryl or aryl. Each R′ may be independently hydrogen or hydrocarbyl, for instance, lower alkyl of up to 7 carbon atoms (e.g., methyl, ethyl, butyl or heptyl). R″ may be independently aromatic (mononuclear or fused polynuclear) hydrocarbon, representative of an aromatic amine or polyamine as described below. The dicarboxylic acids, anhydrides or alkyl esters thereof typically contain up to 25 carbon atoms total, or up to 15 carbon atoms. Examples may include maleic acid or anhydride, or succinimide derivatives thereof; benzyl maleic anhydride; chloro maleic anhydride; heptyl maleate; itaconic acid or anhydride; citraconic acid or anhydride; ethyl fumarate; fumaric acid; mesaconic acid; ethyl isopropyl maleate; isopropyl fumarate; hexyl methyl maleate; and phenyl maleic anhydride. Maleic anhydride, maleic acid and fumaric acid and the lower alkyl esters thereof are often used.

The oil used in grafting the pendant carbonyl containing group on the polymer backbone may comprise an oil of lubricating viscosity. The oil may be a natural and/or synthetic oil. The oil may comprise a hydrocracked, hydrogenated, hydrotreated, unrefined, refined, or re-refined oil, or a mixture of two or more thereof.

Unrefined oils are those obtained directly from a natural or synthetic source generally without (or with little) further purification treatment.

Refined oils are similar to the unrefined oils except they have been further treated in one or more purification steps to improve one or more properties. Purification techniques are known in the art and include solvent extraction, secondary distillation, acid or base extraction, filtration, percolation and the like.

Re-refined oils are also known as reclaimed or reprocessed oils, and are obtained by processes similar to those used to obtain refined oils and often are additionally processed by techniques directed to removal of spent additives and oil breakdown products.

The natural oils may include animal oils, vegetable oils (e.g., castor oil, lard oil), mineral lubricating oils such as liquid petroleum oils and solvent-treated or acid-treated mineral lubricating oils of the paraffinic, naphthenic or mixed paraffinic-naphthenic types and oils derived from coal or shale or mixtures thereof.

The synthetic oils may include hydrocarbon oils such as polymerized and interpolymerized olefins (e.g., polybutylenes, polypropylenes, propyleneisobutylene copolymers); poly(1-hexenes), poly(1-octenes), poly(1-decenes), and mixtures thereof; alkyl-benzenes (e.g. dodecylbenzenes, tetradecylbenzenes, dinonylbenzenes, di-(2-ethylhexyl)-benzenes); polyphenyls (e.g., biphenyls, terphenyls, alkylated polyphenyls); alkylated diphenyl ethers and alkylated diphenyl sulphides and the derivatives, analogs and homologs thereof or mixtures thereof.

Other synthetic oils that may be used may include liquid esters of phosphorus-containing acids (e.g., tricresyl phosphate, trioctyl phosphate, and the diethyl ester of decane phosphonic acid), and polymeric tetrahydrofurans. Synthetic oils may be produced by Fischer-Tropsch reactions and typically may be hydroisomerised Fischer-Tropsch hydrocarbons or waxes. In one embodiment oils may be prepared by a Fischer-Tropsch gas-to-liquid synthetic procedure as well as other gas-to-liquid oils.

The oil may comprise one or more oils as specified in the American Petroleum Institute (API) Base Oil Interchangeability Guidelines. The five base oil groups are as follows: Group I (sulphur content>0.03 wt %, and/or <90 wt % saturates, viscosity index 80-120); Group II (sulphur content≦0.03 wt %, and ≧90 wt % saturates, viscosity index 80-120); Group III (sulphur content≦0.03 wt %, and ≧90 wt saturates, viscosity index>120); Group IV (all polyalphaolefins (PAOs)); and Group V (all others not included in Groups I, II, III, or IV). The oil of lubricating viscosity comprises an API Group I, Group II, Group III, Group IV, Group V oil or mixtures thereof. Often the oil of lubricating viscosity is an API Group I, Group II, Group III, Group IV oil or mixtures thereof. Alternatively the oil of lubricating viscosity is often an API Group I, Group II, Group III oil or mixtures thereof.

The initiator may comprise a hydrocarbyl peroxide or a dihydrocarbyl peroxide wherein either or both of the hydrocarbyl groups may be alkyl (e.g., tert-butyl, tert-amyl, lauryl), cumyl or benzoyl. The initiator may comprise an alkyl perester or peracid where the alkyl group may be tert-butyl or lauryl. The initiator may comprise an alkanoate such as ethylhexanoate, benzoate, pivalate, isobutyrate, or a mixture of two or more thereof. The initiator may comprise one or more of the peroxide initiators available from Akzo Nobel under the commercial tradenames Trigonox® or Perkadox®.

The grafting of the carbonyl containing group on the polymer backbone involves reacting a carbonyl containing compound with a polymer comprising a vinyl aromatic block and an olefin polymer block in oil, in the presence of an initiator, at a temperature in the range from 90° C. to 250° C., or from 140° C. to 210° C. The concentration of the polymer in the oil may be in the range from 10 to 600 grams per kilogram (g/kg), or from 50 to 400 g/kg. The ratio of the carbonyl containing compound to polymer may be in the range from 5 to 60 grams of carbonyl containing compound per kilogram of polymer (g/kg), or from 15 to 40 g/kg. The ratio of initiator to polymer may be in the range from 2 to 60 grams of initiator per kilogram of polymer (g/kg), or from 7.5 to 40 g/kg. The loading of the carbonyl containing group on the polymer backbone may be in the range from 0.5 to 6% by weight, or from 1.5 to 4% by weight.

Optionally the grafting of the carbonyl containing group on the polymer backbone may be carried out by reacting a carbonyl containing compound with a polymer comprising a vinyl aromatic block and an olefin polymer block in oil, in the presence of an initiator, using reactive extrusion at a temperature in the range from 90° C. to 300° C., or from 150° C. to 250° C. The concentration of the polymer in the oil may be in the range from 200 to 990 g/kg, or from 500 to 900 g/kg. The concentration of the carbonyl containing compound to polymer may be in the range from 5 to 60 g/kg, or from 15 to 40 g/kg. The ratio of initiator to polymer may be in the range from 2 to 60 gram initiator per kilogram of polymer (g/kg), or from 7.5 to 40 g/kg. The loading of the carbonyl containing group on the polymer backbone may be from 0.5 to 6% by weight, or from 1.5 to 4.0% by weight.

In addition to grafted polymer, the product formed by the grafting reaction may further comprise grafted oil. Grafted oil comprises oil with the carbonyl containing group grafted on the oil. The “grafted oil” refers to those molecules of the oil that have reacted with the grafting agent to impart the carbonyl-containing moiety (as distinct from the molecules of the oil that have not reacted). The weight ratio of grafted polymer to grafted oil may be in the range from 5:1 to 1:5, or from 3:1 to 2:1.

The grafting reaction may involve the reaction of a styrene olefin polymer, e.g., a styrene butadiene resin (SBR), with maleic anhydride (MAA) in oil in the presence of an initiator. The reaction may be represented by the equation:

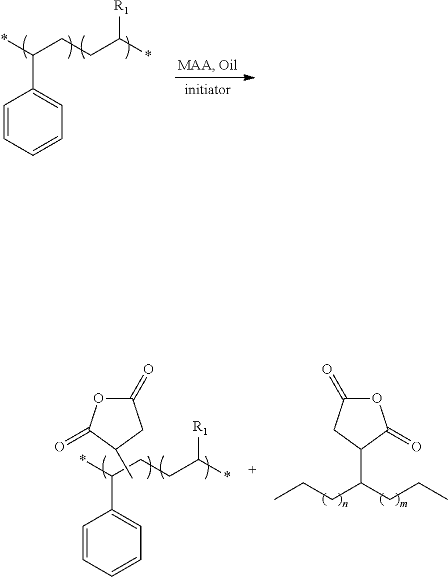

In the above equation R₁, may be hydrogen or an alkyl group of 1 to 10 carbon atoms, or 1 to 4 carbon atoms. The oil may be any of the oils discussed above. A specific example is Nexbase™ 3050 (a product of Neste oil identified as hydrotreated neutral base oil). The temperature may be in the range from 100 to 250° C., or from 140 to 210° C. The resulting succinic anhydride loading on the SBR backbone may be from 0.01 to 10% by weight, or from 0.2 to 5.0% by weight. The foregoing equation indicates that the product comprises a mixture of grafted polymer and grafted oil. The grafting level of grafted polymer to grafted oil may be from 50:1 to 1:5 or from 10:1 to 1:1 by weight. The weight average molecular weight of the grafted polymer may be in the range from 1000 to 1,000,000, or 5,000 to 500,000, or 10,000 to 250,000, or 50,000 to 175,000.

The polydispersity of the grafted polymer may be in the range from 1 to 1.6, or 1.01 to 1.55, or 1 to 1.4, or 1.01 to 1.2.

The grafted polymer may comprise a backbone derived from 5 to 70 mol %, or 10 mol % to 60 mol %, or 20 mol % to 60 mol % of the alkenyl arene monomer e.g., styrene.

The grafted polymer may comprise a backbone derived from 30 to 95 mol %, or 40 mol % to 90 mol %, or 40 mol % to 80 mol % of an olefin monomer, typically a diene, e.g., butadiene.

The grafted polymer may be a block copolymer and may include regular, random, tapered or alternating architectures. The block copolymer may be either a di-block AB copolymer, or a tri-block ABA copolymer. Often the polymer is a di-block AB copolymer. In one embodiment the polymer is other than a tapered copolymer.

The grafted polymer may be a sequential block, random block or regular block copolymer. In one embodiment the grafted polymer is sequential block copolymer.

As used herein the term “sequential block copolymer” means that the copolymer consists of discrete blocks (A and B), each made up of a single monomer. Examples include of a sequential block copolymer include those with A-B or B-A-B architecture.

The grafted polymer may be a linear or a branched copolymer.

The grafted polymer may be a diblock sequential block copolymer, or a diblock normal diblock copolymer.

In one embodiment the grafted polymer is not a triblock or higher block copolymer.

### Alcohol-Functionalized Polymer

In one embodiment the grafted polymer of the invention further comprises an ester group, typically from the reaction of the carbonyl-containing functional group with an alcohol. Suitable alcohols may contain 1 to 40, or 6 to 30 carbon atoms.

Examples of suitable alcohols include Oxo Alcohol® 7911, Oxo Alcohol® 7900 and Oxo Alcohol® 1100 of Monsanto; Alphanol® 79 of ICI; Nafol® 1620, Alfol® 610 and Alfol® 810 of Condea (now Sasol); Epal® 610 and Epal® 810 of Ethyl Corporation; Linevol® 79, Linevol® 911 and Dobanol® 25 L of Shell AG; Lial® 125 of Condea Augusta, Milan; Dehydad® and Lorol® of Henkel KGaA (now Cognis) as well as Linopol® 7-11 and Acropol® 91 of Ugine Kuhlmann. Other alcohols include polyols such as pentaerythritol or neopentyl glycol.

### Amine-Functionalized Polymer

The grafted polymer of the invention may further comprise a nitrogen-containing group. The carbonyl containing group of the grafted polymer may be reacted with a nitrogen-containing monomer or an amine to form an amine functionalized polymer containing an amide and/or imide group. The amine may be an amine with a primary and/or secondary nitrogen.

Examples of suitable nitrogen-containing monomers may include (meth)acrylamide or a nitrogen containing (meth)acrylate monomer (where “(meth)acrylate” or “(meth)acrylamide” represents both the acrylic or methacrylic materials). Typically the nitrogen-containing compound comprises a (meth)acrylamide or nitrogen containing (meth)acrylate monomer and may be represented by the formula:

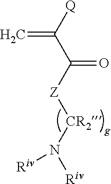

wherein

Q is hydrogen or methyl and, in one embodiment, Q is methyl;

Z is an N—H group or O (oxygen);

each R′″ is independently hydrogen or a hydrocarbyl group containing 1 to 2 carbon atoms and, in one embodiment, each R′″ is hydrogen;

each R^{iv} is independently hydrogen or a hydrocarbyl group containing 1 to 8 or 1 to 4 carbon atoms; and

g is an integer from 1 to 6 and, in one embodiment, g is 1 to 3.

Examples of suitable nitrogen-containing monomers include N,N-dimethylacrylamide, N-vinyl carbonamides (such as, N-vinyl-formamide, N-vinylacetoamide, N-vinyl-n-propionamides, N-vinyl-1-propionamides, N-vinyl hydroxyacetoamide), vinyl pyridine, N-vinyl imidazole, N-vinyl pyrrolidinone, N-vinyl caprolactam, dimethylaminoethyl acrylate, dimethylaminoethyl methacrylate, dimethylaminobutylacrylamide, dimethylaminopropyl methacrylate, dimethylaminopropylacrylamide, dimethylaminopropylmethacrylamide, dimethylaminoethylacrylamide or mixtures thereof.

The amine may be aromatic. Aromatic amines include those which can be represented by the general structure NH₂—Ar or T-NH—Ar, where T may be alkyl or aromatic, Ar is an aromatic group, including nitrogen-containing aromatic groups and Ar groups including any of the following structures:

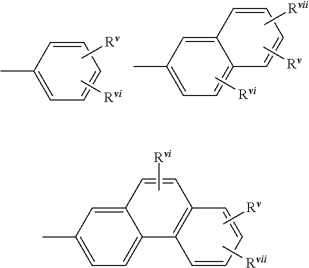

as well as multiple non-condensed or linked aromatic rings. In these and related structures, R^{v}, R^{vi}, and R^{vii} can be independently, among other groups disclosed herein, —H, —C₁₋₁₈ alkyl groups, nitro groups, —NH—Ar, —N═N—Ar, —NH—CO—Ar, —OOC—Ar, —OOC—C₁₋₁₈ alkyl, —COO—C₁₋₁₈ alkyl, —OH, —O—(CH₂CH₂—O)ₙC₁₋₁₈ alkyl groups, and —O—(CH₂CH₂O)ₙAr (where n is 0 to 10).

Aromatic amines include those amines wherein a carbon atom of the aromatic ring structure is attached directly to the amino nitrogen. The amines may be monoamines or polyamines. The aromatic ring will typically be a mononuclear aromatic ring (i.e., one derived from benzene) but can include fused aromatic rings, especially those derived from naphthalene. Examples of aromatic amines include aniline, N-alkylanilines such as N-methylaniline and N-butylaniline, di-(para-methylphenyl)amine, 4-aminodiphenylamine, N,N-dimethylphenylene-diamine, naphthylamine, 4-(4-nitrophenylazo)aniline (disperse orange 3), sulfamethazine, 4-phenoxyaniline, 3-nitroaniline, 4-aminoacetanilide (N-(4-aminophenyl)acetamide)), 4-amino-2-hydroxy-benzoic acid phenyl ester (phenyl amino salicylate), N-(4-amino-phenyl)-benzamide, various benzylamines such as 2,5-dimethoxybenzylamine, 4-phenylazoaniline, and substituted versions of these. Other examples include para-ethoxyaniline, para-dodecylaniline, cyclohexyl-substituted naphthylamine, and thienyl-substituted aniline. Examples of other suitable aromatic amines include amino-substituted aromatic compounds and amines in which the amine nitrogen is a part of an aromatic ring, such as 3-aminoquinoline, 5-aminoquinoline, and 8-aminoquinoline. Also included are aromatic amines such as 2-aminobenzimidazole, which contains one secondary amino group attached directly to the aromatic ring and a primary amino group attached to the imidazole ring. Other amines include N-(4-anilinophenyl)-3-aminobutanamide or 3-amino propyl imidazole. Yet other amines include 2,5-dimethoxybenzylamine.

Additional aromatic amines and related compounds are disclosed in U.S. Pat. Nos. 6,107,257 and 6,107,258; some of these include aminocarbazoles, benzoimidazoles, aminoindoles, aminopyrroles, amino-indazolinones, aminoperimidines, mercaptotriazoles, aminopheno-thiazines, aminopyridines, aminopyrazines, aminopyrimidines, pyridines, pyrazines, pyrimidines, aminothiadiazoles, aminothiothiadiazoles, and aminobenzotriazoles. Other suitable amines include 3-amino-N-(4-anilinophenyl)-N-isopropyl butanamide, and N-(4-anilinophenyl)-3-{(3-aminopropyl)-(cocoalkyl)amino}butanamide. Other aromatic amines which can be used include various aromatic amine dye intermediates containing multiple aromatic rings linked by, for example, amide structures. Examples include materials of the general structure

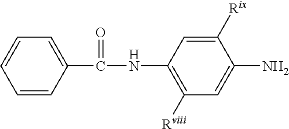

and isomeric variations thereof, where R^{viii} and R^{ix} are independently alkyl or alkoxy groups such as methyl, methoxy, or ethoxy. In one instance, R^{viii} and R^{ix} are both —OCH₃ and the material is known as Fast Blue RR [CAS#6268-05-9].

In another instance, R^{ix} is —OCH₃ and R^{viii} is —CH₃, and the material is known as Fast Violet B [99-21-8]. When both R^{viii} and R^{ix} are ethoxy, the material is Fast Blue BB [120-00-3]. U.S. Pat. No. 5,744,429 discloses other aromatic amine compounds, particularly aminoalkylphenothiazines. N-aromatic substituted acid amide compounds, such as those disclosed in U.S. Patent application 2003/0030033 A1, may also be used for the purposes of this invention. Suitable aromatic amines include those in which the amine nitrogen is a substituent on an aromatic carboxyclic compound, that is, the nitrogen is not sp² hybridized within an aromatic ring.

The aromatic amine may have an N—H group capable of condensing with the pendant carbonyl containing group. Certain aromatic amines are commonly used as antioxidants. Of particular importance in that regard are alkylated diphenylamines such as nonyldiphenylamine and dinonyldiphenylamine. To the extent that these materials will condense with the carboxylic functionality of the polymer chain, they are also suitable for use within the present invention. However, it is believed that the two aromatic groups attached to the amine nitrogen may lead to steric hindrance and reduced reactivity. Thus, suitable amines include those having a primary nitrogen atom (—NH₂) or a secondary nitrogen atom in which one of the hydrocarbyl substituents is a relatively short chain alkyl group, e.g., methyl. Among such aromatic amines are 4-phenylazoaniline, 4-aminodiphenylamine, 2-aminobenzimidazole, and N,N-dimethylphenylenediamine. Some of these and other aromatic amines may also impart antioxidant performance to the polymers, in addition to dispersancy and other properties.

In one embodiment of the invention, the amine component of the reaction product further comprises an amine having at least two N—H groups capable of condensing with the carboxylic functionality of the polymer. This material is referred to hereinafter as a “linking amine” as it can be employed to link together two of the polymers containing the carboxylic acid functionality. It has been observed that higher molecular weight materials may provide improved performance, and this is one method to increase the material's molecular weight. The linking amine can be either an aliphatic amine or an aromatic amine; if it is an aromatic amine, it is considered to be in addition to and a distinct element from the aromatic amine described above, which typically will have only one condensable or reactive NH group, in order to avoid excessive crosslinking of the polymer chains. Examples of such linking amines include ethylenediamine, phenylenediamine, and 2,4-diaminotoluene; others include propylenediamine, hexamethylenediamine, and other, ω-polymethylenediamines. The amount of reactive functionality on such a linking amine can be reduced, if desired, by reaction with less than a stoichiometric amount of a blocking material such as a hydrocarbyl-substituted succinic anhydride.

In one embodiment the amine comprises nitrogen-containing compounds capable of reacting directly with a polymer backbone. Examples of suitable amines include N-p-diphenylamine 1,2,3,6-tetrahydrophthalimide, 4-anilinophenyl methacrylamide, 4-anilinophenyl maleimide, 4-anilinophenyl itaconamide, acrylate and methacrylate esters of 4-hydroxydiphenylamine, the reaction product of p-amino-diphenylamine or p-alkylaminodiphenylamine with glycidyl methacrylate, the reaction product of p-aminodiphenylamine with isobutyraldehyde, derivatives of p-hydroxydiphenylamine; derivatives of phenothiazine, vinyl-containing derivatives of diphenylamine, or mixtures thereof.

### Concentrates and Lubricating Compositions

The grafted polymer may be provided in concentrate form. The concentrate may comprise the grafted polymer and a diluent. The diluent may be any of the oils discussed above. The grafted polymer may be used in a fully formulated lubricant composition. If the grafted polymer of the present invention is in the form of a concentrate (which may be combined with additional oil to form, in whole or in part, a fully formulated lubricant), the ratio of the grafted polymer to the diluent may be from 1:99 to 99:1 by weight, or from 80:20 to 10:90 by weight.

The fully formulated lubricating composition may comprise a major amount of one or more of the above discussed oils of lubricating viscosity, and a minor dispersant viscosity modifying amount of the grafted polymer. The concentration of the grafted polymer in the lubricating composition may be in the range from 100 to 100,000 parts per million (ppm), or from 5000 to 15,000 ppm, or from 7000 to 9000 ppm, or 8000 ppm.

The concentrates and lubricating compositions may optionally comprise other performance additives. The other performance additives may comprise at least one of metal deactivators, conventional detergents (detergents prepared by processes known in the art), dispersants, viscosity modifiers, friction modifiers, antiwear agents, corrosion inhibitors, dispersant viscosity modifiers, extreme pressure agents, antiscuffing agents, antioxidants, foam inhibitors, demulsifiers, pour point depressants, seal swelling agents and mixtures thereof. Typically, fully-formulated lubricating oil will contain one or more of these performance additives.

### Dispersants

Dispersants are often known as ashless-type or ashless dis-persants because, prior to mixing in a lubricating oil composition, they do not contain ash-forming metals and they do not normally contribute any ash forming metals when added to a lubricant and polymeric dispersants. Ashless type dispersants are characterized by a polar group attached to a relatively high molecular weight hydrocarbon chain. Typical ashless dispersants include N-substituted long chain alkenyl succinimides. Examples of N-substituted long chain alkenyl succinimides include polyisobutylene succinimide with number average molecular weight of the polyisobutylene substituent in the range 350 to 5000, or 500 to 3000. Succinimide dispersants and their preparation are disclosed, for instance in U.S. Pat. No. 4,234,435. Succinimide dispersants are typically the imide formed from a polyamine, typically a poly(ethyleneamine).

In one embodiment the invention further comprises at least one dispersant derived from polyisobutylene succinimide with number average molecular weight of the polyisobutylene component in the range 350 to 5000, or 500 to 3000. The polyisobutylene succinimide may be used alone or in combination with other dispersants.

In one embodiment the invention further comprises at least one dispersant derived from polyisobutylene, an amine and zinc oxide to form a polyisobutylene succinimide complex with zinc. The polyisobutylene succinimide complex with zinc may be used alone or in combination.

Another class of ashless dispersant is Mannich bases. Mannich dispersants are the reaction products of alkyl phenols with aldehydes (especially formaldehyde) and amines (especially polyalkylene polyamines). The alkyl group typically contains at least 30 carbon atoms.

The dispersants may also be post-treated by conventional methods by a reaction with any of a variety of agents. Among these are boron, urea, thiourea, dimercaptothiadiazoles, carbon disulphide, aldehydes, ketones, carboxylic acids, hydrocarbon-substituted succinic anhydrides, maleic anhydride, nitriles, epoxides, phosphorus compounds and/or metal compounds.

The dispersant may be present at 0 wt % to 20 wt %, or 0.1 wt % to 15 wt %, or 0.1 wt % to 10 wt %, or 1 wt % to 6 wt %, or 7 wt % to 12 wt % of the lubricating composition.

### Detergents

The lubricant composition optionally further comprises other known neutral or overbased detergents. Suitable detergent substrates include phenates, sulphur containing phenates, sulphonates, salixarates, salicylates, carboxylic acids, phosphorus acids, mono- and/or di-thiophosphoric acids, alkyl phenols, sulphur coupled alkyl phenol compounds, or saligenins. Various overbased detergents and their methods of preparation are described in greater detail in numerous patent publications, including WO2004/096957 and references cited therein.

The detergent may be present at 0 wt % to 10 wt %, or 0.1 wt % to 8 wt %, or 1 wt % to 4 wt %, or greater than 4 to 8 wt %.

### Antioxidants

Antioxidant compounds are known and include for example, sulphurised olefins, diphenylamines, hindered phenols, molybdenum compounds (such as molybdenum dithiocarbamates), and mixtures thereof. Antioxidant compounds may be used alone or in combination. The antioxidant may be present in ranges 0 wt % to 20 wt %, or 0.1 wt % to 10 wt %, or 1 wt % to 5 wt %, of the lubricating composition.

Aromatic amine antioxidants include those of the formula

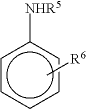

wherein R⁵ can be an aromatic group such as a phenyl group, a naphthyl group, or a phenyl group substituted by R⁷, and R⁶ and R⁷ can be independently a hydrogen or an alkyl group containing 1 to 24 or 4 to 20 or 6 to 12 carbon atoms. In one embodiment, an aromatic amine antioxidant can comprise an alkylated diphenylamine such as nonylated diphenylamine of the formula

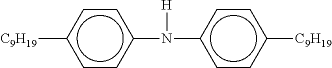

or a mixture of a di-nonylated and a mono-nonylated diphenylamine.

The hindered phenol antioxidant often contains a secondary butyl and/or a tertiary butyl group as a sterically hindering group. The phenol group is often further substituted with a hydrocarbyl group and/or a bridging group linking to a second aromatic group. Examples of suitable hindered phenol antioxidants include 2,6-di-tert-butylphenol, 4-methyl-2,6-di-tert-butylphenol, 4-ethyl-2,6-di-tert-butyl phenol, 4-propyl-2,6-di-tert-butylphenol or 4-butyl-2,6-di-tert-butylphenol, or 4-dodecyl-2,6-di-tert-butylphenol. In one embodiment the hindered phenol antioxidant is an ester and may include, e.g., Irganox™ L-135 from Ciba. A more detailed description of suitable ester-containing hindered phenol antioxidant chemistry is found in U.S. Pat. No. 6,559,105.

Suitable examples of molybdenum dithiocarbamates which may be used as an antioxidant include commercial materials sold under the trade names such as Molyvan 822™ and Molyvan™ A from R. T. Vanderbilt Co., Ltd., and Adeka Sakura-Lube™ S-100, S-165 and S-600 from Asahi Denka Kogyo K. K and mixtures thereof.

### Viscosity Modifiers

Although the grafted polymers of the present invention may serve as dispersant viscosity modifiers, additional viscosity modifiers of other types may also be present. These viscosity modifiers are well known materials and include hydrogenated styrene-butadiene resins, ethylene-propylene copolymers, hydrogenated styrene-isoprene polymers, hydrogenated radical isoprene polymers, poly(meth)acrylates (often polyalkylmethacrylates), polyalkyl styrenes, polyolefins and esters of maleic anhydride-styrene copolymers, or mixtures thereof. Such additional viscosity modifiers may be present in ranges including 0 wt % to 15 wt %, or 0.1 wt % to 10 wt % or 1 wt % to 5 wt % of the lubricating composition.

### Antiwear Agents

The lubricant composition optionally further comprises at least one other antiwear agent. The antiwear agent may be present in ranges including 0 wt % to 15 wt %, or 0.1 wt % to 10 wt % or 1 wt % to 8 wt % of the lubricating composition. Examples of suitable antiwear agents include phosphate esters, sulphurised olefins, sulphur-containing ashless anti-wear additives are metal dihydrocarbyldithiophosphates (such as zinc dialkyldithiophosphates), thiocarbamate-containing compounds, such as thiocarbamate esters, thiocarbamate amides, thiocarbamic ethers, alkylene-coupled thiocarbamates, and bis(S-alkyldithiocarbamyl) disulphides.

The dithiocarbamate-containing compounds may be prepared by reacting a dithiocarbamate acid or salt with an unsaturated compound. The dithiocarbamate containing compounds may also be prepared by simultaneously reacting an amine, carbon disulphide and an unsaturated compound. Generally, the reaction occurs at a temperature of 25° C. to 125° C. U.S. Pat. Nos. 4,758,362 and 4,997,969 describe dithiocarbamate compounds and methods of making them.

Examples of suitable olefins that may be sulphurised to form a sulphurised olefin include propylene, butylene, isobutylene, pentene, hexane, heptene, octane, nonene, decene, undecene, dodecene, undecyl, tridecene, tetradecene, pentadecene, hexadecene, heptadecene, octadecene, octadecenene, nonodecene, eicosene or mixtures thereof. In one embodiment, hexadecene, heptadecene, octadecene, octadecenene, nonodecene, eicosene or mixtures thereof and their dimers, trimers and tetramers are especially useful olefins. Alternatively, the olefin may be a Diels-Alder adduct of a diene such as 1,3-butadiene and an unsaturated ester, such as, butylacrylate.

Another class of sulphurised olefin includes fatty acids and their esters. The fatty acids are often obtained from vegetable oil or animal oil; and typically contain 4 to 22 carbon atoms. Examples of suitable fatty acids and their esters include triglycerides, oleic acid, linoleic acid, palmitoleic acid or mixtures thereof. Often, the fatty acids are obtained from lard oil, tall oil, peanut oil, soybean oil, cottonseed oil, sunflower seed oil or mixtures thereof. In one embodiment fatty acids and/or ester are mixed with olefins.

In an alternative embodiment, the ashless antiwear agent may be a monoester of a polyol and an aliphatic carboxylic acid, often an acid containing 12 to 24 carbon atoms. Often the monoester of a polyol and an aliphatic carboxylic acid is in the form of a mixture with a sunflower oil or the like, which may be present in the friction modifier mixture include 5 to 95, or in other embodiments 10 to 90, or 20 to 85, or 20 to 80 weight percent of said mixture. The aliphatic carboxylic acids (especially a monocarboxylic acid) which form the esters are those acids typically containing 12 to 24 or 14 to 20 carbon atoms. Examples of carboxylic acids include dodecanoic acid, stearic acid, lauric acid, behenic acid, and oleic acid.

Polyols include diols, triols, and alcohols with higher numbers of alcoholic OH groups. Polyhydric alcohols include ethylene glycols, including di-, tri- and tetraethylene glycols; propylene glycols, including di-, tri- and tetrapropylene glycols; glycerol; butane diol; hexane diol; sorbitol; arabitol; mannitol; sucrose; fructose; glucose; cyclohexane diol; erythritol; and pentaerythritols, including di- and tripentaerythritol. Often the polyol is diethylene glycol, triethylene glycol, glycerol, sorbitol, penta-erythritol or dipentaerythritol.

The commercially available monoester known as “glycerol monooleate” is believed to include 60±5 percent by weight of the chemical species glycerol monooleate, along with 35±5 percent glycerol dioleate, and less than 5 percent trioleate and oleic acid. The amounts of the monoesters, described above, are calculated based on the actual, corrected, amount of polyol monoester present in any such mixture.

### Antiscuffing Agents

The lubricant composition may also contain an antiscuffing agent. Antiscuffing agent compounds are believed to decrease adhesive wear are often sulphur-containing compounds. Typically the sulphur-containing compounds include organic sulphides and polysulphides, such as dibenzyldisulphide, bis-(chlorobenzyl) disulphide, dibutyl tetrasulphide, di-tertiary butyl polysulphide, sulphurised methyl ester of oleic acid, sulphurised alkylphenol, sulphurised dipentene, sulphurised terpene, sulphurised Diels-Alder adducts, alkyl sulphenyl N,N-dialkyl dithiocarbamates, the reaction product of polyamines with polybasic acid esters, chlorobutyl esters of 2,3-dibromopropoxyisobutyric acid, acetoxymethyl esters of dialkyl dithiocarbamic acid and acyloxyalkyl ethers of xanthogenic acids and mixtures thereof.

### Extreme Pressure Agents

Extreme Pressure (EP) agents that are soluble in the oil include sulphur- and chlorosulphur-containing EP agents, chlorinated hydrocarbon EP agents and phosphorus EP agents. Examples of such EP agents include chlorinated wax; organic sulphides and polysulphides such as dibenzyldisulphide, bis-(chlorobenzyl) disulphide, dibutyl tetrasulphide, sulphurised methyl ester of oleic acid, sulphurised alkylphenol, sulphurised dipentene, sulphurised terpene, and sulphurised Diels-Alder adducts; phosphosulphurised hydrocarbons such as the reaction product of phosphorus sulphide with turpentine or methyl oleate; phosphorus esters such as the dihydrocarbon and trihydrocarbon phosphites, e.g., dibutyl phosphite, diheptyl phosphite, dicyclohexyl phosphite, pentyl phenyl phosphite; dipentyl phenyl phosphite, tridecyl phosphite, distearyl phosphite and polypropylene substituted phenol phosphite; metal thiocarbamates such as zinc dioctyldithiocarbamate and barium heptylphenol diacid; the zinc salts of a phosphorodithioic acid; amine salts of alkyl and dialkylphosphoric acids, including, for example, the amine salt of the reaction product of a dialkyldithiophosphoric acid with propylene oxide and P₂O₅; and mixtures thereof.

### Other Additives

Other performance additives such as corrosion inhibitors include those described in paragraphs 5 to 8 of US Application US05/038319 (filed on Oct. 25, 2004 McAtee and Boyer as named inventors), octylamine octanoate, condensation products of dodecenyl succinic acid or anhydride and a fatty acid such as oleic acid with a polyamine. In one embodiment the corrosion inhibitors include the Synalox® corrosion inhibitor. The Synalox corrosion inhibitor is typically a homopolymer or copolymer of propylene oxide. The Synalox® corrosion inhibitor is described in more detail in a product brochure with Form No. 118-01453-0702 AMS, published by The Dow Chemical Company. The product brochure is entitled “SYNALOX Lubricants, High-Performance Polyglycols for Demanding Applications.”

Metal deactivators including derivatives of benzotriazoles, dimercaptothiadiazole derivatives, 1,2,4-triazoles, benzimidazoles, 2-alkyldithiobenzimidazoles, or 2-alkyldithiobenzothiazoles; foam inhibitors including copolymers of ethyl acrylate and 2-ethylhexylacrylate and optionally vinyl acetate; demulsifiers including trialkyl phosphates, polyethylene glycols, polyethylene oxides, polypropylene oxides and (ethylene oxide-propylene oxide) polymers; pour point depressants including esters of maleic anhydride-styrene, polymethacrylates, polyacrylates or polyacrylamides; and friction modifiers including fatty acid derivatives such as amines, esters, epoxides, fatty imidazolines, condensation products of carboxylic acids and polyalkylene-polyamines and amine salts of alkylphosphoric acids may also be used in the lubricant composition. Friction modifiers may be present in ranges including 0 wt % to 10 wt % or 0.1 wt % to 8 wt % or 1 wt % to 5 wt % of the lubricating composition.

### INDUSTRIAL APPLICATION

The grafted polymer of the invention may be suitable for any lubricant composition. The grafted polymer may be employed as a dispersant viscosity modifier (often referred to as a DVM).

In one embodiment the grafted polymer of the invention may provide at least one of acceptable viscosity modifying performance, acceptable dispersant performance, and/or acceptable soot and sludge handling. When the grafted polymer of the invention is used in an engine oil lubricant composition, it may provide acceptable fuel economy performance and/or acceptable soot and sludge handling.

Examples of a lubricant include an engine oil for a 2-stroke or a 4-stroke internal combustion engine, a gear oil, an automatic transmission oil, a hydraulic fluid, a turbine oil, a metal working fluid or a circulating oil.

In one embodiment the internal combustion engine may be a diesel fuelled engine, a gasoline fuelled engine, a natural gas fuelled engine or a mixed gasoline/alcohol fuelled engine. In one embodiment the internal combustion engine is a diesel fuelled engine and in another embodiment a gasoline fuelled engine.

The internal combustion engine may be a 2-stroke or 4-stroke engine. Suitable internal combustion engines include marine diesel engines, aviation piston engines, low-load diesel engines, and automobile and truck engines.

The lubricant composition for an internal combustion engine may be suitable for any engine lubricant irrespective of the sulphur, phosphorus or sulphated ash (ASTM D-874) content. The sulphur content of the engine oil lubricant may be 1 wt % or less, or 0.8 wt % or less, or 0.5 wt % or less, or 0.3 wt % or less. The phosphorus content may be 0.2 wt % or less, or 0.1 wt % or less, or 0.085 wt % or less, or even 0.06 wt % or less, 0.055 wt % or less, or 0.05 wt % or less. The total sulphated ash content may be 2 wt % or less, or 1.5 wt % or less, or 1.1 wt % or less, or 1 wt % or less, or 0.8 wt % or less, or 0.5 wt % or less.

In one embodiment the lubricating composition is an engine oil, wherein the lubricating composition has a (i) a sulphur content of 0.5 wt % or less, (ii) a phosphorus content of 0.1 wt % or less, and (iii) a sulphated ash content of 1.5 wt % or less.

In one embodiment the lubricating composition is suitable for a 2-stroke or a 4-stroke marine diesel internal combustion engine. In one embodiment the marine diesel combustion engine is a 2-stroke engine. The grafted polymer of the invention may be added to a marine diesel lubricating composition at 0.01 to 20 wt %, or 0.05 to 10 wt %, or 0.1 to 5 wt %.

### Example 1

50 g of Dyne™ 623-14 are added over a period of 30 minutes to 450 ml of Nexbase™ 3050 (product of Neste Oil identified as a hydrotreated neutral base oil) in a one-liter flask equipped with a nitrogen inlet, addition funnel, stirrer, reflux condenser and immersion temperature probe. The mixture is stirred (300 RPM) under nitrogen (28 L/hr; 1 SCFH) for 1 hour. The temperature is increased to 180° C. and stirred for 1.5 hours. Molten maleic anhydride (2.50 g) is added. A mixture of t-butyl peroxide (1.24 g) in Nexbase™ 3050 (55.56 g) is added over a period of 5 minutes. The reaction mixture is stirred for an additional hour. The reaction mixture is cooled to 170° C. Vacuum is applied to the reaction mixture (16 kPa pressure (635 mm Hg vacuum)) for 30 minutes. The reaction mixture is cooled to room temperature. The product comprises an SBR resin with maleic anhydride (MAA) grafted onto the SBR resin. The grafted resin may be represented by the formula SBR-g-MAA. The yield is 556.4 g (99.5%). The total graft level is 0.37% by weight MAA. The graft efficiency is 7%. The level of free MAA is less than 50 ppm. The amount of MAA grafted onto the SBR is 0.96% by weight. Oil grafted maleic anhydride, that is, MAA grafted on oil (oil-g-MAA) is also formed. The amount of MAA grafted onto the total oil portion is 0.36% by weight.

### Example 2

107.3 g of the product from Example 1 are charged to a 500 ml flask equipped with a stirrer, reflux condenser, addition funnel, nitrogen inlet and thermocouple. 107.3 g of Nexbase™ are added while heating to 150° C. and gradually increasing the stirring rate from 50 to 400 RPM to yield a styrene butadiene resin (SBR) grafted with maleic anhydride (MAA) in Nexbase™ 3050 at 10.7% actives. The reaction mixture is stirred at 150° C. for 2 hours and heated to 170° C. to reduce viscosity and allow efficient mixing and rapid incorporation of amine. 2.63 g of 4-aminodiphenylamine (ADPA) are added to the reaction mixture. The reaction mixture is cooled over a period of 1 hour to 150° C., and then stirred for 18 hours. 0.22 g of dimethylaminopropyl amine (DMAPA) are added subsurface to the reaction mixture over a period of 5 minutes. The reaction mixture is stirred for 2 hours and cooled to 130° C. The desired product is an amine functionalized grafted resin which may be represented by the formula SBR-g-MAA/ADPA/DMAPA. The yield is 213.5 g.

### Example 3

Drain oil containing 3.15% soot is blended with amine functionalized grafted resins. The grafted resins are made by grafting MAA on SBR in oil in the presence of an initiator. The amine is ADPA. The SBR is Dyne 623-14 or Dyne 623-18. The oil is Nexbase 3050. The initiator is di-tertiary-butyl phenol (DTBP). The oil phase grafting is conducted at a high temperature of 180° C. or 200° C. The high temperature allows facile removal of unreacted MAA by application of vacuum. The reaction conditions for the grafting and the results are summarized in Table 1.

TABLE 1

| | | | | | | | | MAA Graft | Free | | |
|---|---|---|---|---|---|---|---|---|---|---|---|
| | | MAA:SBR | Initiator | Temp | Oil | TAN | MAA | Efficiency | MAA | KV100 | GPC THF |
| Sample | SBR | (w:w) | MAA:DTBP | (° C.) | (wt %) | (NN_40) | (wt %) | (%) | (ppm) | (cSt) | (Mw/Mn) |
| 1 | 623-14 | 5 | 3:1 | 180 | 91 | 4.21 | 0.37 | 7 | <50 | 736 | 99200 |
| | | | | | | | | | | | 68000 |
| 2 | 623-18 | 8 | 5:1 | 200 | 78.6 | 14.95 | 1.31 | 16 | 467 | | 89800 |
| | | | | | | | | | | | 44000 |
| 3 | 623-18 | 8 | 3:1 | 200 | 86.5 | 10.90 | 0.95 | 12 | 123 | 2913 | 89500 |
| | | | | | | | | | | | 58000 |

Sample 3 is prepared by grafting the MAA on the SBR in oil at 200° C. The concentration of SBR in the oil is 13.5% by weight. The resulting grafted resin, SBR-g-MAA, is diluted to 10% polymer in oil. Sample 3 at 10% actives by weight polymer compares favorably to Sample 1 at 9% by weight polymer. This is believed to be a result of the use of the high temperature (200° C.) graft procedure used to prepare Sample 3.

Increased concentration leads to increased total graft level in addition to increased proportion on the polymer. This is shown in Table 2.

TABLE 2

| | | | | | | MAA | |
|---|---|---|---|---|---|---|---|
| | Initial actives | | TAN | MAA | TAN ratio | Graft | |
| Sample | (wt %) | Phase | (NN_40) | (wt %) | (SBR:oil) | Efficiency % | GPC THF (Mw/Mn) |
| 4 | 9 | oil | 4.16 | 0.36 | 2.7:1 | 7 | 700/600 (94%) |
| 5 | 9 | solid | 11.00 | 0.96 | | 19 | 101000/63000 (70%) |
| 6 | 21.4 | oil | 13.89 | 1.21 | 2.2:1 | 15 | 2800/1300 (97%) |
| 7 | 21.4 | solid | 30.77 | 2.69 | | 34 | 86600/41000 (92%) |

Samples 1 and 2 from Table 1 are dialysed at room temperature with hexanes to separate grafted oil from grafted polymer to determine the relative graft levels. Samples 4 and 5 are taken from Sample 1 in Table 1. Samples 6 and 7 are taken from Sample 2 in Table 1. The total acid number (TAN) in milligrams of KOH per gram of sample for dried dialysed polymer (Samples 5 and 7) versus the oil/concentrated hexane fraction (Samples 4 and 6), respectively, indicates a higher TAN on the polymer in both cases (TAN ratio 2.7:1 and 2.2:1 respectively). However, although the higher dilution of Sample 1 favors increased TAN for the polymer, the total MAA grafted is relatively higher on oil (Sample 4, 91% of Sample 1) than the polymer (Sample 5, 9% of Sample 1) than it is for dialysed graft Sample 2:

Sample 1: ratio of oil-g-MAA wt % to SBR-g-MAA wt %=3.64:1 (22% MAA grafted on SBR).

Sample 2: ratio of oil-g-MAA wt % to SBR-g-MAA wt %=1.64:1 (38% MAA grafted on SBR).

The amines shown below are used to prepare amine functionalized oil grafted SBR resins.

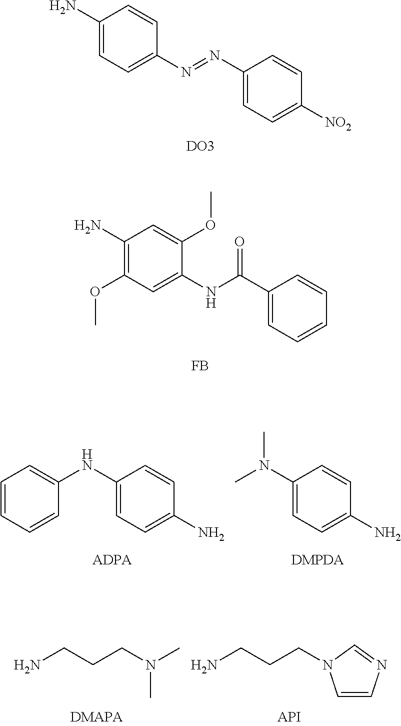

These amines may be identified as follows:

DO3: 4-(4-nitrophenylazo) aniline

FB: Fast Blue Rr

ADPA: aminodiphenyl amine

DMPDA: dimethylphenyl diamine

DMAPA: dimethylaminopropyl amine

API: aminopropylimidazole

The polymers are post treated to cap the anhydrides with DMAPA. FB, DO3, DMAPA and API provide good soot affinity. ADPA is incorporated into systems containing DO3 and FB to minimize cost impact, effect on seals and amine reactivity, and maintain good soot dispersancy. Table 3 provides viscometric data for samples of SBR-g-MAA (grafted in Nexbase 3050) functionalized with the above-indicated amines.

TABLE 3

| | | | | | GPC | | | KV100 |
|---|---|---|---|---|---|---|---|---|
| Sample | MAA | Amine | post treat | N % | Mw/Mn | PDI | TAN (NN_40) | (cSt) |
| 8 | 1.31% | ADPA | DMAPA | 0.189 | 72900 | | | 467 |
| | | | | | 44000 | | | |
| 9 | 1.31% | ADPA/FB (7:3) | DMAPA | 0.191 | 69800 | 1.66 | 0.45 | 313 |
| | | | | | 42000 | | | |
| 10 | 1.31% | ADPA/FB (9:1) | DMAPA | 0.19 | 70900 | 1.64 | 0.43 | 318 |
| | | | | | 43000 | | | |
| 11 | 0.95% | 1-(3-aminopropyl) | DMAPA | 0.438 | 64200 | 1.58 | 0.57 | 528 |
| | | imidazole | | | 41000 | | | |
| 12 | 0.95% | N,N-dimethyl-1,4- | DMAPA | 0.219 | 92900 | 1.36 | 0.53 | 662 |
| | | phenylene diamine | | | 68000 | | | |
| 13 | 0.95% | ADPA | DMAPA | 0.275 | 92300 | 1.41 | 0.72 | 500 |
| | | | | | 65000 | | | |
| 14 | 0.95% | ADPA/FB (9:1) | DMAPA | 0.377 | 92200 | 1.45 | 0.61 | 491 |
| | | | | | 63000 | | | |
| 15 | 0.95% | DMAPA | | 0.384 | 92500 | 1.46 | 0.36 | 417 |
| | | | | | 63000 | | | |
| 16 | 0.95% | ADPA:DO3 (9:1) | DMAPA | 0.36 | 93700 | 1.45 | 2.30 | 513 |
| | | | | | 65000 | | | |

Soot screen testing is performed on the polymer samples by adding the polymer sample to a drain oil containing 3.7% by weight soot. The resulting test sample is subjected to oscillation and the ability of the polymer to reduce the buildup of associations between molecules of soot is measured as a modulus, by a method described in SAE Paper 2001-01-1967, “Understanding Soot Mediated Oil Thickening: Rotational Rheology Techniques to Determine Viscosity and Soot Structure in Peugot XUD-11 BTE Drain Oils,” M. Parry, H. George, and J. Edgar, presented at International Spring Fuels & Lubricants Meeting & Exhibition, Orlando, Fla., May 7-9, 2001. This test may be referred to as the XUD-11 test. The calculated parameter is referred to as G′ (Pa). The G′ (Pa) of the test sample treated with the polymer additive is compared to the G′ (Pa) of the drain oil without the additive, the latter of which is defined as 1.00. Values of G′ (Pa) less than 1.00 indicate increasing effectiveness at soot dispersion.

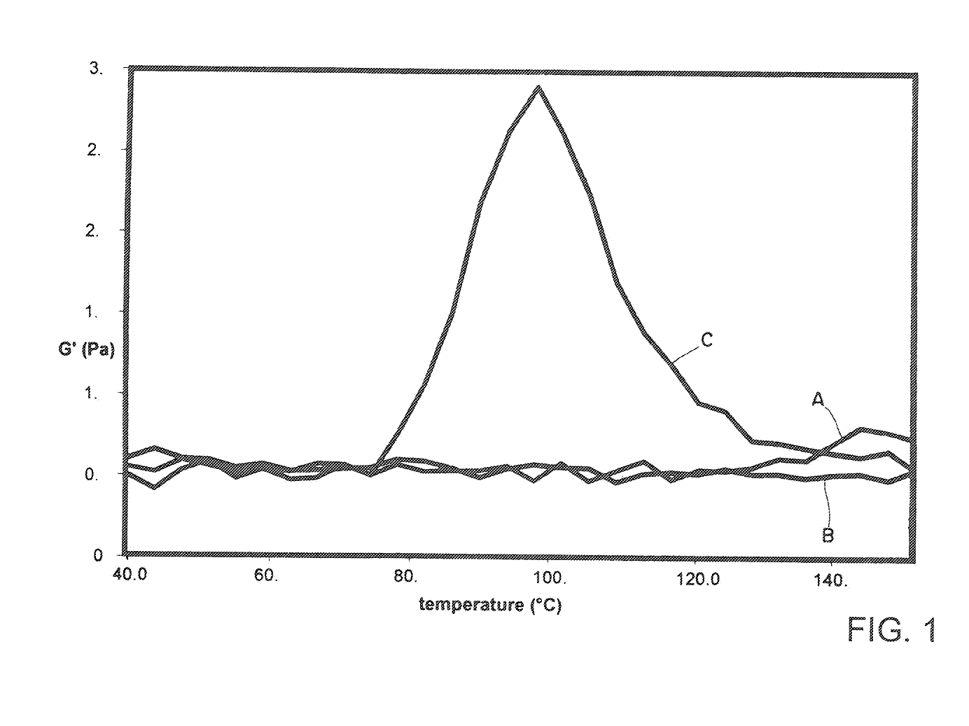

XUD-11 soot screen rheology of Sample 8 shows excellent soot handling at 0.5 and 1% loadings in sooted drain oil, both loadings essentially preventing soot structure build up. This result improves on solutions of SBR-g-MAA/ADPA at equal treat and approximately equal graft levels. This is believed to be due to improved oil solubility. This is shown in FIG. 1. In FIG. 1, curve A is for 1% loading, curve B is for 0.5% loading, and curve C is for untreated drain oil.

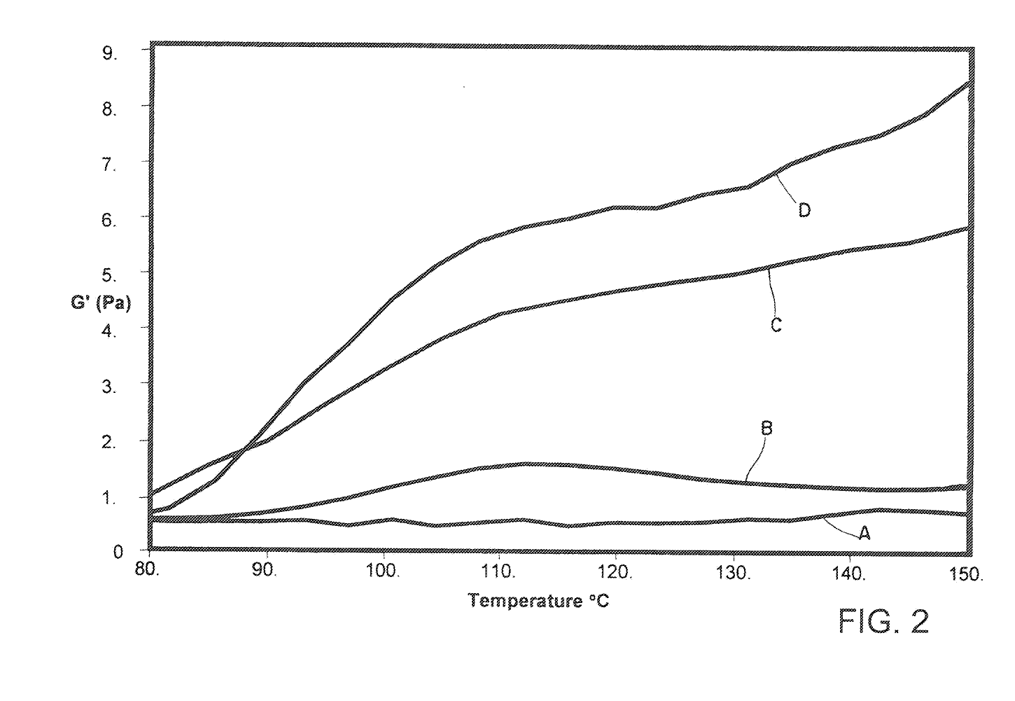

The independent effect of a low molecular weight grafted material on soot dispersion was not known prior to this invention, i.e. would it disperse the soot or not on its own. It was anticipated that the grafted oil would be deleterious to the grafted polymer dispersancy as the smaller molecules may bind preferentially to the soot surface, displacing the grafted polymer but without the soot solubilizing capacity of the grafted polymer. Sample 8 (SBR-g-MAA/ADPA) is dialysed in hexanes in order to examine the soot handling capacity of the grafted oil. This is shown in FIG. 2, wherein the results of testing in sooted drain oil containing 3.7% by weight soot is disclosed. In FIG. 2, curve A is for undialysed Sample 8 (0.5% active, 2.7% MAA graft), curve B is for the grafted polymer from the dialysed Sample 8 (SBR-g-MAA/ADPA, 0.5% active, 1.3% MAA graft), curve C is for the grafted oil from the dialysed Sample 8 (oil-g-MAA/ADPA, 9.5% active, 1.2% total graft), and curve D is for untreated sooted drain oil.

The oil phase obtained from dialysis is treated at the same level (9.5 wt %) in sooted drain oil containing 3.7% by weight soot as required to achieve 0.5 wt % polymer in FIG. 1. The rheology trace indicates negligible soot solubilizing in direct contrast to excellent soot handling of 0.5% dialysed Sample 8 (SBR-g-MAA/ADPA) shown in FIG. 2 (including 9.5% oil).

The foregoing is believed to establish that almost all the soot dispersancy observed in the XUD-11 soot screen test is attributable to the grafted polymer. The grafted oil does not appear to appreciably displace the grafted polymer from the soot surface despite its low mass/better accessibility as no reduction in soot dispersion is observed in the undialysed Sample 8 compared to the grafted polymer from the dialysed Sample 8. While not wishing to be bound by theory, it is believed that this may be a result of stabilization of the interaction between the soot and the grafted polymer by chelation of multiple sites by the grafted polymer or possibly transient interactions whereby the grafted oil displaces the grafted polymer partially but attachment of the grafted polymer elsewhere on the soot facilitates a rapid reattachment.

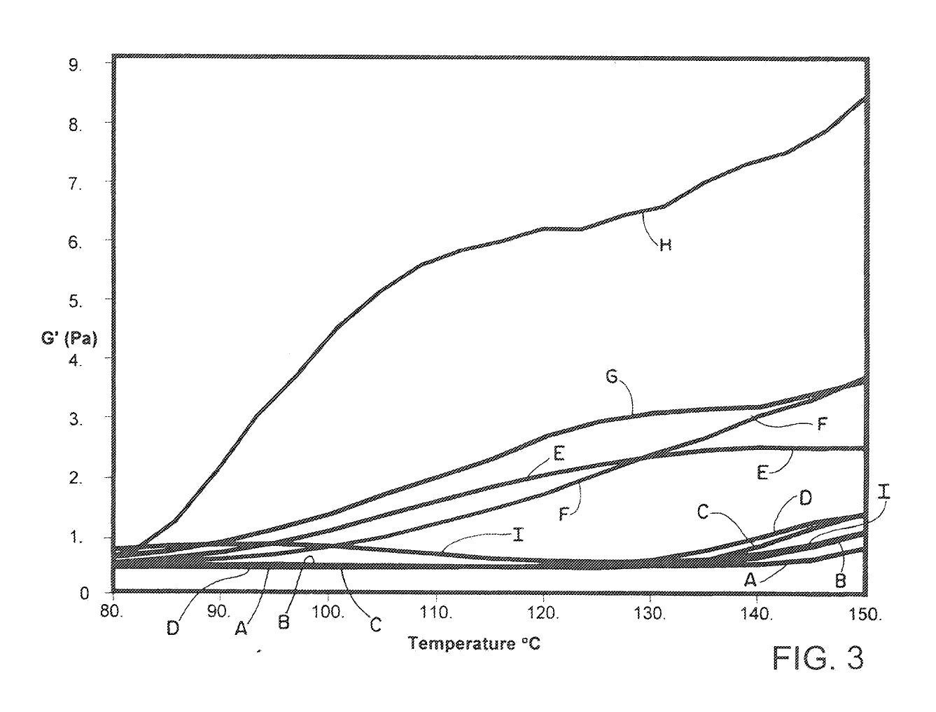

XUD-11 soot screen testing for Samples 9-16 is shown in FIG. 3. The treat level for each of the Samples 9-16 is 0.5% by weight. The curves in FIG. 3 correspond to Samples 9-16 as follows:

| Curve | Sample |
|---|---|
| A | 9 |
| B | 16 |
| C | 14 |
| D | 13 |
| E | 15 |
| F | 11 |
| G | 12 |
| H | Untreated drain oil |
| I | 10 |

The results indicated that increasing graft levels leads to improved soot handling. The results also indicate that increasing proportions of DO3 and FB at equal graft levels improves soot handling. DO3 outperforms FB at equal graft levels.

Samples 9 and 10 from Table 3 are examined using a test drain oil from a Mack T-11 engine. The results are shown in Table 4. The Mack T-11 results for Samples 9 and 10 show good performance compared to Afton Hitec™ 5777, which is regarded as being a typical baseline excellent soot handling DVM.

TABLE 4

| Sample ID | treat rate (%) | Max G′ (Pa) | ratio |
|---|---|---|---|
| Hitec 5777 | 1 | 0.368 | 0.205 |
| | 2 | 0.278 | 0.155 |
| Sample 9 | 1 | 0.694 | 0.387 |
| | 2 | 0.409 | 0.228 |
| Sample 10 | 1 | 0.758 | 0.423 |
| | 2 | 0.313 | 0.175 |
| Untreated Mack | none | 1.791 | |
| T-11 drain oil | | | |

The prior art, as disclosed in U.S. Pat. No. 5,429,758 to Hayashi, indicates that it is to be expected that the grafting of a styrene butadiene copolymer in oil would result in only 20-30% of the resultant total acid number (TAN) on the polymer backbone. However, in Sample 2 of the invention, a grafted polymer in oil is prepared where greater than 35% of the resulting TAN is on the polymer. This is even more impressive in view of the fact that Sample 2 is prepared in a polymer to oil weight ratio of 21.4:78.6, as compared to Example IV of Hayashi which has a more favorable polymer to oil weight ratio of 25:75. The data is summarized below.

TABLE 5

| | | | | | | | | | Ratio of |
|---|---|---|---|---|---|---|---|---|---|
| | | % | | | Neat | Prod- | | | Poly- |
| Sam- | | Poly- | Prod- | Neat | Poly- | uct | | Poly- | mer:Oil |
| ple | % Oil | mer | uct | Oil | mer | calc | Oil | mer | Graft |
| 2 | 78.6 | 21.4 | 14.95 | 13.89 | 30.77 | 17.50 | 62.4 | 37.6 | 2.22 |
| Ex | 75 | 25 | 5.4 | 5.04 | 6.48 | 5.40 | 70.0 | 30.0 | 1.29 |
| IV* | | | | | | | | | |

*Assume 30% of TAN from polymer as disclosed in Hayashi.

While the invention has been explained in relation to various embodiments, it is to be understood that various modifications thereof may become apparent to those skilled in the art upon reading the specification. Therefore, it is to be understood that the invention provided for herein is intended to cover such modifications as may fall within the scope of the appended claims.

1. A composition, comprising:
a grafted polymer comprising a polymer backbone and a pendant carbon-yl containing group, the backbone comprising at least one of block A and at least one of block B, block A comprising an olefin polymer block, block B comprising a vinyl aromatic polymer block, the mole ratio of monomer units in block A to monomer units in the combination of block A plus block B being in the range from 0.5 to 0.9;
the pendant carbonyl containing group being grafted on block A and/or block B, the carbonyl containing group being optionally further substituted to provide an ester, imide and/or amide functionality, the grafting of the pendant carbonyl containing group on to block A and/or block B being conducted in oil at a temperature in the range from 100 to 250° C. in the presence of an initiator.

2. The composition of claim 1 wherein the composition further comprises grafted oil, the grafted oil comprising oil with a carbonyl containing group grafted on the oil.

3. The composition of claim 2 wherein the weight ratio of grafted polymer to grafted oil is in the range from 5:1 to 1.5:1.

4. The composition of claim 1, wherein the grafted polymer comprises a copolymer that is not a tapered copolymer, and block A contains from 20 mol % to 80 mol % repeat units that contain alkyl branching groups; or wherein the grafted polymer comprises a copolymer which is a tapered copolymer, and block A contains from 40 mol % to 80 mol % repeat units that contain alkyl branching groups.

5. The composition of claim 1, wherein the grafted polymer comprises repeat units derived from an aliphatic diene and repeat units derived from an alkenyl arene.

6. The composition of claim 1, wherein the grafted polymer comprises a backbone comprising repeat units derived from styrene and butadiene.

7. The composition of claim 1, wherein the grafted polymer comprises a diblock copolymer or a sequential block copolymer.

8. The composition of claim 1, wherein the pendant carbonyl-containing group is derived from a carboxylic acid or a derivative thereof, the derivative comprising an anhydride, halide, or alkyl ester.

9. The composition of claim 1, wherein the grafted polymer has a weight average molecular weight in the range from 1000 to 1,000,000; or wherein the grafted polymer has a polydispersity in the range from 1 to 1.6.

10. The composition of claim 1, wherein the initiator comprises a hydrocarbyl peroxide, a dihydrocarbyl peroxide, an alkyl perester, an alkyl peracid, an alkanoate, or a mixture of two or more thereof.

11. The composition of claim 1, wherein the carbonyl containing group is substituted to provide amide and/or imide functionality, the amide and/or imide functionality being provided by an amine.

12. A concentrate comprising the composition of claim 1 and a diluent, the weight ratio of the grafted polymer to the diluent being in the range from 1:99 to 99:1.

13. A lubricating composition comprising a major amount of an oil of lubricating viscosity and a minor dispersant viscosity modifying amount of the composition of claim 1.

14. (canceled)

15. A process, comprising:
grafting a carbonyl containing group onto a polymer backbone in oil in the presence of an initiator at a temperature in the range from 100° C. to 250° C. to form a grafted polymer;
the polymer backbone comprising block A and block B, block A comprising at least one olefin polymer block, block B comprising at least one vinyl aromatic polymer block, the mole ratio of block A to the combination of block A plus block B being in the range from 0.5 to 0.9;
the carbonyl containing group being derived from a carboxylic acid or de-rivative thereof, the derivative being an anhydride, halide or alkyl ester, the carbonyl containing group being grafted on block A and/or block B, the carbonyl containing group being optionally further substituted to provide ester, imide and/or amide functionality.

16. The composition of claim 8 wherein the carboxylic acid or de-rivative thereof is maleic anhydride.

17. A method for lubricating an internal combustion engine, a gear, an automatic transmission, a hydraulic device, a turbine, or a worked metal surface, comprising supplying thereto the composition of claim 1.
